(19) United States
(12) Patent Application Publication
(10) Pub. No.: US 2006/0011048 A1
(43) Pub. Date: Jan. 19, 2006

(54) Stringed musical instrument derived from harps

(76) Inventor: Michael John Koster, Fremont, CA (US)

Correspondence Address: Michael John Koster, 336 Orchard Drive, Fremont, CA, 94536, US

(21) Appl. No.: 11/176,109

(22) Filed: Jul. 6, 2005

Related U.S. Application Data
(60) Provisional application No. 60/585,891, filed on Jul. 7, 2004.

(51) Int. Cl. G10H 3/00

(52) U.S. Cl. 84/723

(57) ABSTRACT

A new musical instrument comprises a thin solid or semi-hollow body and a triangular or trapezoidal frame across which a plurality of strings are disposed in the manner of harps. The instrument has frets, which allows the player a unique form of expression not available on harps. The instrument is small and light enough to be carried or held with a shoulder strap while being played, offering the player greater mobility. The instrument may additionally have built-in special effects that may be controlled by an expression control device or lever, offering the player even greater expression and mobility. The instrument also may have a special built-in hum and noise canceling preamplifier to improve the quality of the output signal. Certain additional design improvements and conveniences are provided for better playability and practicality.

### CROSS-REFERENCE TO RELATED APPLICATIONS

This application claims the benefit of PPA Ser. No. 60/585,891, filed 2004 JUL 07 by the present inventor.

### FEDERALLY SPONSORED RESEARCH

Not Applicable

### BACKGROUND OF THE INVENTION

1. Field of Invention

The present invention relates to both acoustic and electric harps, specifically providing a player of the instrument with greater flexibility of movement and greater control over expression, pitch, sound effects, and reduced electrical noise.

2. Prior Art

The harp is a musical instrument that is available in many forms and sizes. The number of strings may vary from fewer than 20 to greater than 40. A smaller harp may be played by positioning it on the lap of the musician. A larger harp rests on the shoulder of the harpist who is seated, such as a pedal harp seen in an orchestra, or is played while standing behind the instrument. Existing harps have limitations in the musician's flexibility of movement and control over expression, pitch, volume, tone, and special sound effects.

Harps have fixed tuning, meaning that without pedals or levers to adjust the pitch of a note, one cannot play accidentals. Fixed tuning also limits flexibility in the use of unusual intonation or special sound effects. The commonly used methods of adjusting pitch on a harp are re-tuning, using sharping levers, or using pedals.

Smaller harps are lighter weight and easier to transport, but limited in their range of expression and pitch control, and the number of octaves available. Larger harps are heavy and cumbersome to carry, and although levers or pedals enable some pitch control, they are still limited in their range of expression.

Electric harps and acoustic-electric harps are also currently being manufactured, with either levers or pedals enabling pitch control. Electric harps share additional disadvantages. They typically contain a piezoelectric pickup on each string; the pickup generates hum and electrical noise. Current electric harps also require connection to separate stationary boxes or units in order to create special effects, which limits the performer's freedom of movement.

Both acoustic and electric harps have the disadvantage of typically being large and heavy, requiring that they be played from a fixed position on the floor with the performer sitting or standing behind them. A performer is therefore unable to move around the stage with the instrument, for example moving closer to the audience to build rapport, interacting with fellow musicians on stage, or enhancing the excitement of the performance through movement, as is common with guitar players.

Some smaller electric harps can be strapped to the musician, enabling the performer to walk while playing; however, such harps are still relatively heavy, they do not contain on-board expression and sound effects, and they have only standard limited pitch control.

The lyre is an ancient stringed instrument that is seldom found in current use or manufacture. The lyre typically had fewer strings than a harp and was tuned in a similar manner. It was held on the lap or held close to the chest with one hand while played with the other. The current invention employs these small and easy-to-hold features.

Other prior art includes a stringed instrument called a harp guitar. The harpolyre patented in the 1800s is a form of harp guitar. The harp guitar is basically a guitar which, as is typical with guitars, has a long, straight neck with a fingerboard and strings parallel to the neck. It employs the addition of only a few harp strings; these strings are open, unstopped and unfretted. The harp strings are typically used as drones and are plucked, and they have no frets or other pitch control devices. The harp guitar is played like a guitar both in technique and in position held.

Among the many distinguishing features of the current invention are that all of its strings are equally capable of being played with either guitar technique or harp technique, more of the strings have frets for changing pitch, and it is held like a lyre.

3. Objects and Advantages

The present invention is a small, easily held instrument that provides a player with the sound of a harp plus many objects and advantages:
(a) Provides the ability to play accidentals and incorporate expressive gestures by employing frets at the upper end of the strings such as those found on fretted instruments such as guitars.
(b) Provides a built-in expression controller easily accessible to the player to enable sounds not previously heard from a harp.
(c) Provides internal sound effects processing circuits easily accessible to the player to enable sounds not previously heard from a harp.
(d) Provides a pitch controller, making possible a wider range of octaves than is otherwise found on a small harp.
(e) Provides built-in volume and tone controls easily accessible to the player, enabling greater sound control than is otherwise possible on a harp.
(f) Provides a high quality output signal by reducing the electrical hum and noise that is common with electric harps.
(g) Allows freedom of movement due to its built-in processors and controllers, instead of employing such features in the standard mode of stationary floor units.
(h) Allows freedom of movement by holding the instrument in front of the chest aided by a brace or strap similar to a guitar strap, due to its small size and light weight, thereby increasing mobility and freedom of interaction with an audience.

### SUMMARY OF THE INVENTION

The present invention is a small, easily held instrument that provides a player with the sound of the harp plus many advantages: freedom of movement, the ability to play accidentals and incorporate expressive gestures, reduced electrical hum and noise, internal sound effect processor units, and an internal expression controller to enable sounds not previously heard from a harp.

According to one aspect of one or more embodiments of the present invention, the instrument consists of a small, thin, solid or semi-hollow body musical instrument and a trapezoidal or triangular frame across which strings are disposed in the manner of a harp.

According to another aspect of one or more embodiments of the present invention, a player holds the instrument in front of the chest, possibly aided by a strap similar to a guitar strap, and with one or two hands plucks the strings in the manner of a harp. This provides a player of the instrument the advantage of increased mobility and freedom of interaction with an audience.

According to another aspect of one or more embodiments of the present invention, the instrument has a number of frets at the upper end of the strings. A player may depress the strings against the frets in order to raise by one or more semitones the pitch of the note played thereby enabling key modulation or enabling expressive gestures such as “hammer on,” “pull off,” and “vibrato” that are familiar to guitar players.

According to another aspect of one or more embodiments of the present invention, the instrument may have an expression controller or associated effects units, the purpose of which is to raise or lower the pitch of the played notes or to otherwise influence the timbre or some other characteristic of the sound produced.

According to another aspect of one or more embodiments of the present invention, the instrument may contain an internal preamplifier with hum and noise canceling circuit to provide a high quality output signal of the correct level and impedance for connection to additional signal processing, amplification, or recording equipment.

### DRAWINGS

FIG. 1 shows a plan view of one embodiment of the present invention.

FIG. 2 shows a block diagram of the signal flow through the instrument.

FIG. 3 shows a detail view of the arrangement of one of a plurality of strings.

FIG. 4 shows a detail view of one embodiment of an expression control lever.

FIG. 5 shows one method of operation of the present invention.

### DETAILED DESCRIPTION

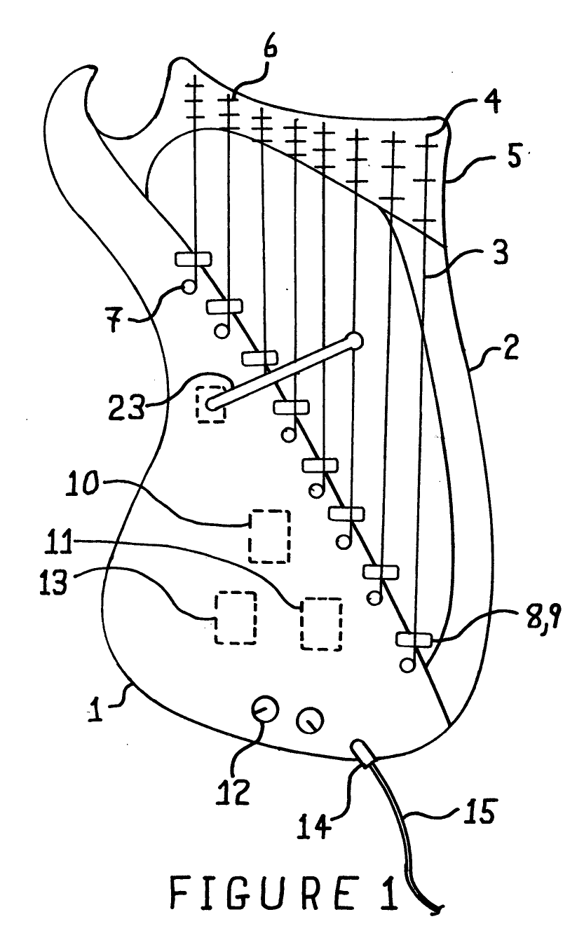

FIG. 1 is a plan view of one or more embodiments of the present invention, showing the body 1 and triangular frame 2 across which the strings 3 are disposed. The length of the strings 3 decreases as the tuned pitched increases. The strings are anchored 4 in the neck 5 and run over a number of semitone-spaced frets 6 similar to guitar frets. Those skilled in the art will realize that the fret spacing will need to vary from string to string for proper intonation.

In one or more embodiments of the present invention, the lower ends of the strings are attached to tuning pegs or tuning machines 7 of various types which allow the string pitches to be musically tuned by adjustment of string tension in the manner of all stringed instruments.

In one or more embodiments of the present invention, the strings pass over saddles or bridges 8 which include piezoelectric transducers 9 to provide electrical signals of the strings' vibration for further processing and amplification.

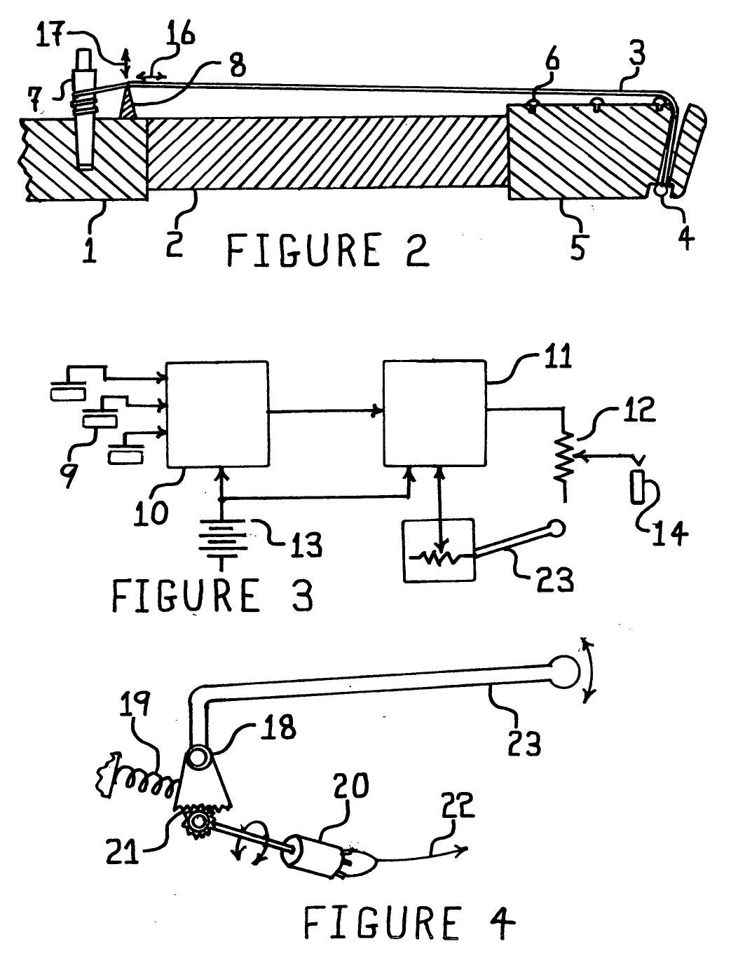

FIG. 2 shows the layout of an individual string in one or more embodiments of the present invention, with its upper anchor point 4, passing over frets 6 continuing downward to the bridges or saddles 8 and affixed to the tuning pegs or tuning machines 7. Those skilled in the art will recognize that the induced angle of the strings over the bridges or saddles will influence the downward force on the bridges, and that there is an optimum value of this force for good sound and playability.

Those skilled in the art will also recognize that it is necessary to provide adjustability in two directions for the bridge or saddle, first along the string length 16 for proper intonation when strings are depressed against the frets, and vertically 17 to adjust the playing height of the strings above the frets for best playability while eliminating buzzing of the vibrating strings against the frets.

FIG. 3 shows the signal flow diagram of one or more embodiments of the present invention. Signals from the saddle transducers 9 are combined and amplified, while common mode noise, hum, and interference is canceled using a differential preamplifier circuit 10, of which the operational principle will be well understood by those skilled in the art. Those skilled in the art will realize that the signal quality of the instrument will be greatly enhanced by “buffering” the high impedance piezoelectric transducers using this differential preamplifier.

In one or more embodiments of the present invention, a built-in effects processor 11 may be provided to alter the pitch or timbre or other quality of the sound from the instrument. It will be recognized by persons skilled in the art that the built-in preamplifier can provide an optimum signal level for input into an effects processor unit.

In one or more embodiments of the present invention, an effects processor may be controlled electronically by a built-in expression control lever 23. An effects processor thus controlled may be internal or external to the body 1 of the instrument.

In one or more embodiments of the present invention, built-in volume and tone controls 12 may be used to control the quality of the resulting sound.

In one or more embodiments of the present invention, the preamplifier and effects processor may be powered by internal batteries 13.

In one or more embodiments of the present invention, the output signal is output to external amplification gear using a standard output jack 14 and signal cable 15.

Embodiments of the present invention may provide single channel (monaural), stereo, or multi channel signals to the external amplification equipment.

FIG. 4 shows the detail of the expression control lever in one or more embodiments of the present invention. The expression lever 23 pivots in a smooth acting bearing 18 against a spring tension 19 to provide smooth feel and controllability. One end of the lever 23 is manipulated by a player of the instrument, and the other end of the lever acts upon a potentiometer 20. In one or more embodiments of the present invention, a geared mechanism 21 couples the lever to the potentiometer such that depressing or raising the lever changes the resistance of the potentiometer and provides a varying control signal 22 to an effects processor. Other embodiments of the present invention may use cables, wheels, or other mechanical apparatus such that motion of the lever causes the resistance of the potentiometer to change. Those skilled in the art will recognize that adjustable motion stops or other calibration means are beneficial.

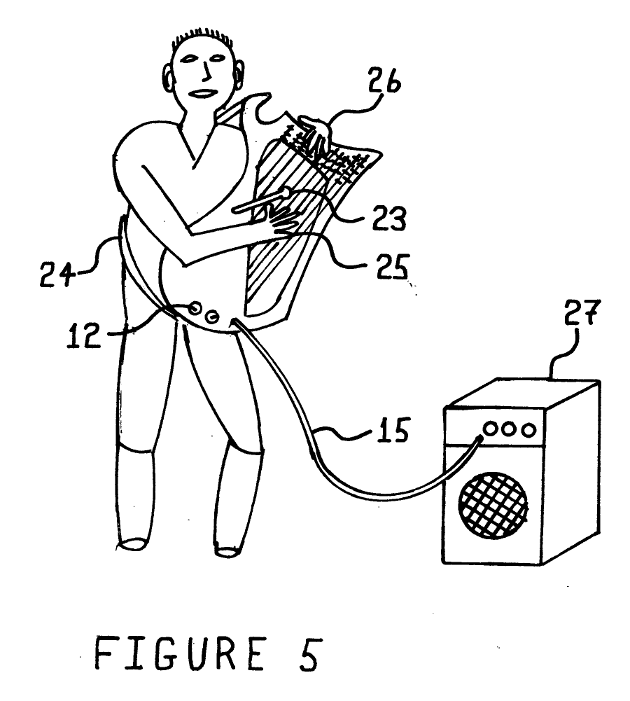

FIG. 5 shows a player of the invention in one mode of operation. A player may use a strap 24 to hold the instrument at chest level while plucking the strings with one hand 25 and depressing the strings against the frets with the other hand 26. Those skilled in the art will recognize that left-handed and right-handed embodiments of the instrument may be desirable.

In one or more modes of operation, the expression lever 23 is manipulated as desired to alter the pitch, volume, or timbre of the resulting notes being played.

The conveniently located volume and tone controls 12 are adjusted as desired by the player.

A signal cable 15 conducts the output signals to an amplifier 27 or sound system to enable the performance to be heard or recorded.

What is claimed is:

1. A musical instrument comprising a solid or semi-hollow body and triangular or trapezoidal frame over which a plurality of strings are disposed in the manner of harps, parallel to the surface of the body, and which is small and light enough to be held or carried while playing.

2. The instrument of claim 1, which is meant to be played using techniques adapted from both harp and fretted instrument playing.

3. The instrument of claim 1, which has a plurality of frets disposed at the upper end of the strings, whereby playing of key modulations, accidentals, and expressive gestures is facilitated.

4. The instrument of claim 1, which has pegs or machine tuning mechanisms disposed at the lower end of the strings, thereby clearing the upper area for the frets.

5. The instrument of claim 1, which has a transducer of one of piezoelectric, magnetic, or optical type transducers disposed at each string, thereby converting string vibration into electrical signals.

6. The instrument of claim 1, which may have adjustable bridges or saddles, thereby facilitating adjustment of playing height and intonation of the strings.

7. The instrument of claim 1, which may have built-in volume and/or tone control devices.

8. The instrument of claim 1, which may have a built-in preamplifier circuit.

9. The capability of claim 8, which may have additional means for providing the correct signal level and impedance for signal processing and amplification or recording equipment.

10. The capability of claim 8, which may have additional means to cancel induced hum or noise from the instrument's pickups and wiring.

11. The instrument of claim 1, which may have built-in special effects processing capability.

12. The capability of claim 11, which may be controlled by a built-in expression control device which is disposed near the hand position, thereby affording the player a greater variety of musical expression.

13. The capability of claim 11, which may provide the ability to shift the intonation of the instrument by some fixed amount, thereby allowing changes in the musical key or range of pitch.
